(19) United States
(12) Patent Application Publication
(10) Pub. No.: US 2005/0102610 A1
(43) Pub. Date: May 12, 2005

(54) Visual electronic library

(76) Inventor: Wei Jie, Vancouver (CA)

Correspondence Address: Wei Jie, 11011 131A St., Surrey, BC, V3T 3S1, CA

(21) Appl. No.: 10/701,982

(22) Filed: Nov. 6, 2003

(51) Int. Cl. G06F 15/00; G06F 17/24

(52) U.S. Cl. 715/513

(57) ABSTRACT

A method and system of generation, organization and presentation of web pages or computer graphic user interfaces on computer, computer peripheral devices, electronic equipment, digital processing systems, and other information resources are disclosed. Modeling physical books, bookshelves and libraries, Visual Library comprises Visual Bookshelves, while Visual Bookshelf comprises Visual Book Covers that represent and link to Visual Books, and Visual Books comprise a set of Visual Navigation Tabs that represent and link a set of web pages or a set of graphic user interfaces. With look-and-feel, the linked Visual Library, Visual Bookshelves and Visual Books in hierarchical structures provide a friendly environment in which the documents, contents can be well organized and easily navigated.

### FIELD OF THE INVENTION

The present invention generally relates to the generation, organization and presentation of web pages (World Wide Web pages) or computer graphic user interfaces on the computer (local computer, network computer or server), computer peripheral device, electronic equipment, digital processing system, and other information resources. By modeling the visual environment and structure of real libraries, bookshelves and books, web pages or graphic user interfaces for document and content management, web sharing and publishing will be better organized and more user friendly.

### BACKGROUND OF THE INVENTION

The Organizational Structure of a Web Site

Usually, a navigation bar, a group of graphics, images or an image map with hyperlinks is used to divide and link the main pages on a web site. However, such navigation bars are not rich in look-and-feel of physical space so users feel hard to remember their current location and the path.

Library, Bookshelf and Book

Conventionally, information and knowledge are managed in the form of books, bookshelves and libraries, which have been familiar to people for thousand years with advantages in displaying information directly and organizing information simply.

Management of Electronic Contents in Book/Library Style

Powered by hyperlinks and search engines, the Internet (World Wide Web) is advanced in sharing information across space in no time. However, the web contents are not well organized compared to conventional information technology—Book/Library Systems. Presentation and management of electronic contents in book and library style will provide a friendlier and more effective user interface.

### BRIEF SUMMARY OF THE INVENTION

A method and system for generating, organizing and presenting web pages or computer graphic user interfaces which are named as Visual Book, Visual Bookshelf and Visual Library on computer, computer peripheral devices, electronic equipment, digital processing systems, and other information resources are disclosed. In preferred embodiments, the present invention is applied on the local computer or computers over the network. The said web pages or computer user interfaces are generated manually or dynamically or updated with the support of computer programming code. The said supporting computer programming code may be server side applications with the communication and construction mechanisms. Preferably, the web pages may be written in Hypertext Markup Language (HTML) but they are not limited to the mentioned languages.

A group of navigation tabs that link a series of web pages or a series of forms of graphic user interfaces and indicate the current location of the pages or forms are named Visual Navigation Tabs. A series of web pages or forms of graphic user interfaces that are linked as a unit by Visual navigation Tabs are named Visual Book. A representative unit of a Visual Book that links to the Visual Book is named the Visual Book Cover.

Visual Bookshelf is a unit that comprises a series of Visual Book Covers and links to the Visual Book Covers. In preferred embodiments, the Visual Bookshelf has the look-and-feel of a physical bookshelf.

Visual Library is a set of structured web pages or graphic user interfaces that comprises a Visual Bookshelf or a group of Visual Bookshelves or their representative images that link to the respective Visual Bookshelves. In preferred embodiments, the Visual Library has the look-and-feel of a physical library. In preferred embodiments, classification of Visual Library can be based on the building units such as those of libraries, stories, doors or windows etc, and there are links to the web pages or the interfaces represented by the building units.

### BRIEF SUMMARY OF THE DRAWINGS

FIG. 1 shows a typical Visual Bookshelf, which comprises Visual Book Covers.

FIG. 2 illustrates by way of example a Visual Bookshelf on a web page.

FIG. 3 shows a typical stripe style Visual Bookshelf, which comprises Visual Book Covers.

FIG. 4 illustrates by way of example a stripe style Visual Bookshelf.

FIG. 4A shows a typical a stripe style Visual Bookshelf comprising a left border image, a title and right border image.

FIG. 5 shows a typical Visual Library Group classification based on buildings and titles.

FIG. 6 shows a typical Visual Library classification based on building units and titles.

FIG. 7 shows a typical Visual Library classification based on building stories and titles.

FIG. 8 shows a typical Visual Library classification based on building inner units and titles.

FIG. 9 illustrates by way of example a typical Visual Library that comprises Visual Bookshelves.

FIG. 10 illustrates by way of example a typical stripe style Visual Library that comprises Visual Bookshelves.

FIG. 11 shows a typical layout of Visual Bookshelves in a Visual Library.

FIG. 12 shows how a typical Visual Bookshelf can be expanded in two directions.

FIG. 13 shows a typical Visual Bookshelf which contains Visual Book Covers in side view.

FIG. 14 shows a typical Visual Bookshelf with the lower potions of Visual Book Covers hidden.

FIG. 15 shows typical Visual Bookshelves with classification tabs on top.

FIG. 16 shows typical Visual Bookshelves with classification tabs on side.

FIG. 17 shows typical Visual Bookshelves with 3-D effect and titles.

FIG. 18 shows typical Visual Bookshelves with 3-D effect and titles in curve.

FIG. 19 shows typical Visual Bookshelves with 3-D effect and titles on top.

FIG. 20 shows typical Visual Bookshelves with 3-D effect in a room unit.

FIG. 20A shows typical Visual Bookshelves with 3-D effect in a Z-shaped unit.

FIG. 21 shows typical side-view effect of Visual Bookshelf images in a row.

FIG. 21A shows typical plan-view effect Visual Bookshelf images in multiple rows.

FIG. 22 shows typical 3-D effect Visual Bookshelves.

FIG. 23 shows a typical layout of Visual Bookshelves in a straight row.

FIG. 24 shows a typical layout of Visual Bookshelves in a curve or a circle.

FIG. 25 shows a typical layout of Visual Bookshelves in a straight row.

FIG. 26 shows a typical layout of Visual Bookshelves in a room unit.

FIG. 27 shows a typical layout of Visual Bookshelves in a Z-shaped unit.

FIG. 28 shows a typical layout of Visual Bookshelves in a circle.

FIG. 29 shows a typical variation in the layout of Visual Bookshelves in FIG. 25.

FIG. 30 shows a typical combination in the layout of Visual Bookshelves in FIG. 25 and FIG. 28.

FIG. 31 shows a typical Visual Book Cover, which comprises cover and title.

FIG. 32 shows a typical Visual Book Cover that represents some papers.

FIG. 33 shows a typical variation of Visual Book Cover—Visual File.

FIG. 34 shows a typical Visual Book Cover with visually binding elements.

FIG. 35 shows a typical Visual Book Cover with the lower potion hidden visually.

FIG. 36 shows a typical Visual Book Cover in side view style.

FIG. 37 shows a typical hierarchical structure of Visual Library, Visual Bookshelf and Visual Book.

FIG. 37A shows a typical hierarchical structure of Visual Books, Chapters, Sections, Pages and Contents.

FIG. 37B shows a hierarchical and linking structure in a typical Visual Library.

FIG. 38A shows a typical Visual Book with Visual Navigation Tabs on top.

FIG. 38B shows a typical Visual Book with Visual Navigation Tabs on the side.

FIG. 38C shows a typical Visual Book with Visual Navigation Tabs both on top and the side.

FIG. 38D shows a typical Visual Book with two-level Visual Navigation Tabs on top.

FIG. 38E shows a typical two-page Visual Book with Visual Navigation Tabs on two sides.

FIG. 38F is a flowchart showing how to customize a Visual Library, Visual Bookshelf or a Visual Book from user interfaces in local computer in preferred embodiments.

FIG. 38G is a flowchart showing how to customize a Visual Library, Visual Bookshelf or Visual Book from user interfaces over client-server network in preferred embodiments.

FIG. 38H indicates typical ways to link a Visual Library, a Visual Bookshelf or a Visual Book from a web page.

FIG. 38I illustrates an example of a Visual Bookshelf in which the Visual Book Covers are in the form of Visual Files.

FIG. 38J illustrates an example of a Visual Bookshelf in which the Visual Book Covers are in form of documents and newspapers.

FIG. 38K illustrates an example of a Visual Bookshelf in which there is no background and border of bookshelf.

FIG. 38L illustrates an example of a Visual Library in which classifications in the form of building units and Bookshelves are combined together on a single interface.

### DETAILED DESCRIPTION OF THE INVENTION

A method and system for generating, organizing and presenting a set of web pages (webpages) or a set of computer graphic user interfaces named as Visual Book, Visual Bookshelf and Visual Library on the computer (local computer, network computer or server), computer peripheral devices, electronic equipment, digital processing systems, and other information resources are disclosed. The said web pages or computer user interfaces are generated manually or dynamically with support of computer programming code. The said web pages may be the extensions or successors of standard web pages or script language supported by Web Forms or Xforms.

In preferred embodiments, the present invention is applied on the local computer or computers over the network. It can be applied on other digital processing systems or digital devices such as digital cameras, digital video cameras, PDAs (Personal Digital Assistant), digital copiers, fax machines and their combinations, e-book viewer, web TV and so forth.

In preferred embodiments, the said supporting computer programming code may be server side applications with communication and construction mechanisms like CGI (Common Gateway Interface) and ASP (Application Server Pages) etc, communicating with Hypertext Markup Language (HTML) web browser user interface via Hypertext Transfer Protocol (HTTP) or other Internet application protocols. Preferably, the web pages may be written in Hypertext Markup Language (HTML). They can be written in the sister and successor languages of HTML such as XML, XHTML or other markup languages.

Visual Bookshelf

A group of navigation tabs that link a set of web pages or graphic user interfaces and indicate the current location of the pages or interfaces are named Visual Navigation Tabs (see detailed descriptions below). A set of web pages or graphic user interfaces that are linked as a unit by Visual Navigation Tabs are named as Visual Books (see detailed descriptions below). A representative unit named the Visual Book Cover links to the Visual Book. (see detailed descriptions below).

The Visual Bookshelf is a unit that comprises a series of Visual Book Covers. In preferred embodiments, Visual Bookshelf has the look-and-feel of a physical bookshelf. A representative image named Visual Bookshelf Image links to Visual Bookshelf.

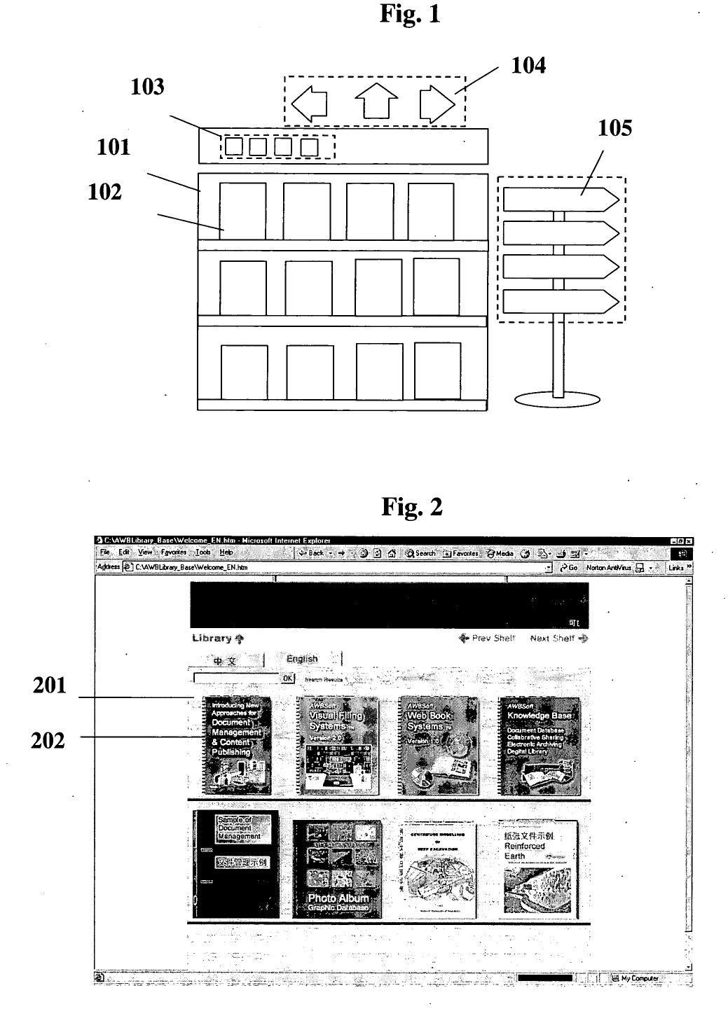

FIG. 1 shows a typical Visual Bookshelf, which comprises Visual Book Covers 102. In preferred embodiments, Visual Bookshelf also comprises classification titles 103, bookshelf background 101 and navigation arrows links 104 which link to the Visual Library or other Visual Bookshelves. In preferred embodiments, Visual Bookshelf comprises navigational board 105, which links to specified locations of Visual Library.

FIG. 2 illustrates an example of a Visual Bookshelf on a web page. Users can click Visual Book Cover 202 on Visual Bookshelf 201 to open the represented Visual Book.

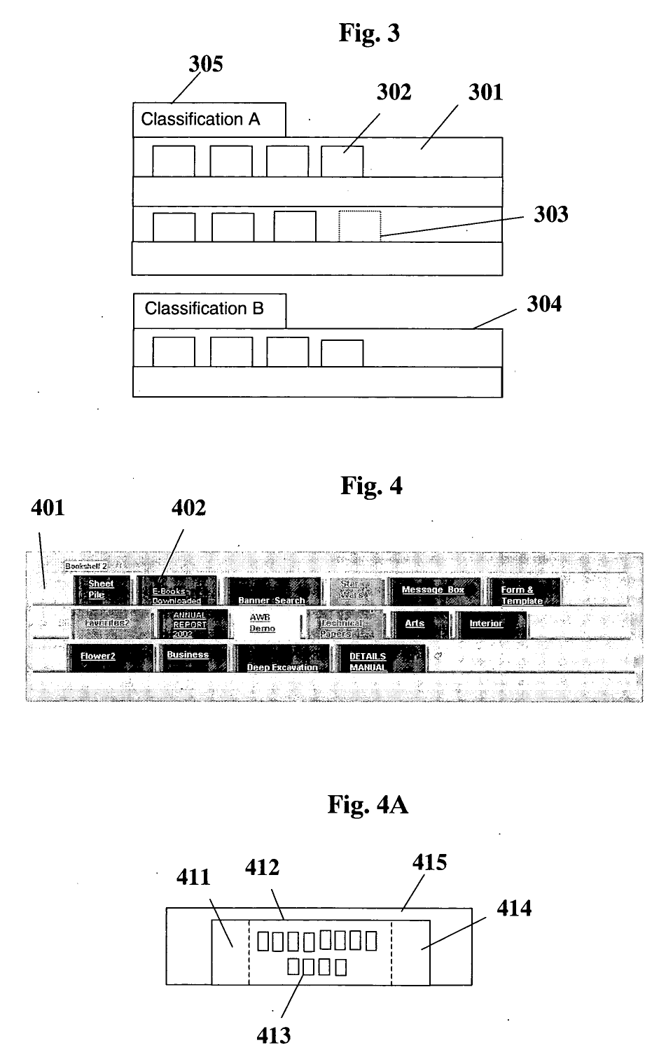

FIG. 3 shows a set of typical stripe style Visual Bookshelves, which comprises Visual Book Covers 302, whose upper portion is hidden. Additionally, the background of bookshelf 301 and classification title 305 can be included in the Visual Bookshelves. Visual Bookshelf 304 represents the additional Visual Bookshelf that can be added on the same interface.

FIG. 4 illustrates an example of a stripe style Visual Bookshelf which comprises bookshelf background 401 and Visual Book Cover 402. In order to conduct the dynamic generation of Visual Bookshelves in preferred embodiments, a typical Visual Book Cover unit is indicated in FIG. 4A.

FIG. 4A shows a typical a stripe style Visual Bookshelf which comprises left cover border 411, middle background 412, book title 413 and right cover border 414, as well as bookshelf background 415.

Visual Library and Visual Library Group

The Visual Library is a set of structured web pages or graphic user interfaces that comprises Visual Bookshelves or their representative images that link to the Visual Bookshelves respectively. In preferred embodiments, Visual Library has the look-and-feel of a physical library.

In preferred embodiments, classification of Visual Library can be based on the building units such as those of libraries, stories, doors or windows etc, and there are links to the web pages or interfaces represented by the building units. On the web pages or interfaces, there are Visual Bookshelves or representative images of Visual Bookshelves with links to the Visual Bookshelves represented. Alternatively, directory signboards can be used to replace the classification in building units or combined together.

Visual Library Group is a set of Visual Libraries with the look and feel of physical libraries. There are representative units of the Visual Libraries as well as links to the Visual Libraries respectively.

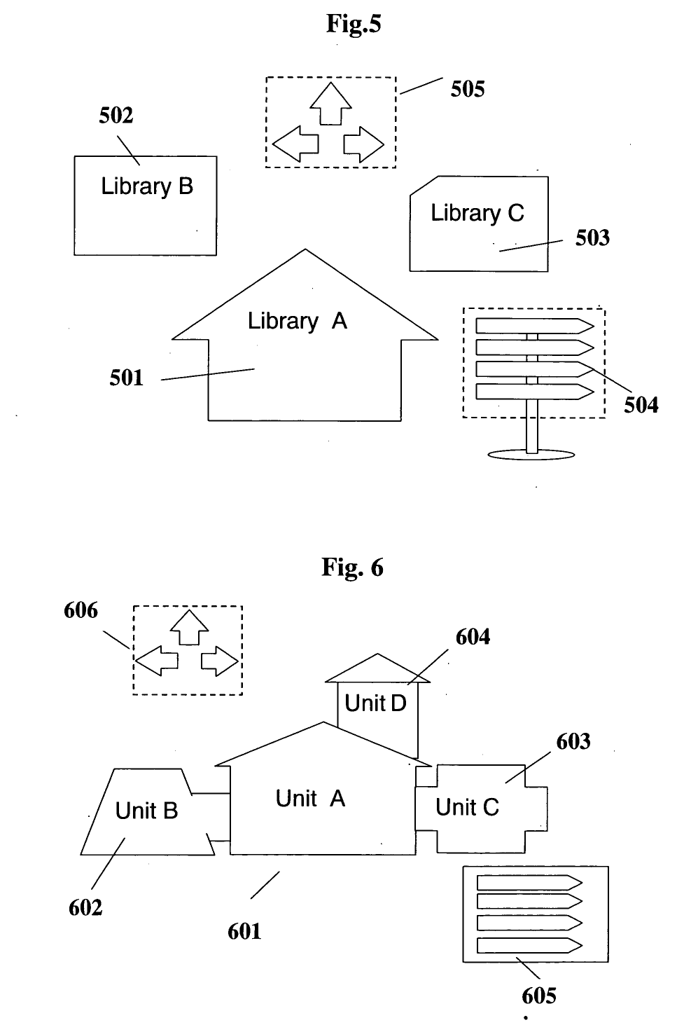

FIG. 5 shows a typical Visual Library Group classification based on buildings and titles. For instance, classified Visual Libraries represent the different departments of a university or different Ministries of a Government. Buildings 501,502,503 and their titles represent and link the Visual Libraries respectively. The representative buildings 501,502,503 (not limited to three numbers) can be in the form of plan view, elevation view, end view, 3-D views in graphic or photographic format. The Visual Library Group can be divided into multiple web pages or interfaces and linked with directory signboard 504 or navigation arrows 505.

FIG. 6 shows a typical Visual Library classification based on building units and titles. For instance, classified building units 601,602,603 and 604 represent the different departments of a library and link to the Visual Libraries respectively. Representative building units 601,602,603 and 604 (not limited to four numbers) can be in the forms of plan view, elevation view, end view or in 3-D effect in graphic or photographic format. The Visual Library can be divided into multiple web pages or interfaces and linked with directory signboard 605 or navigation arrows 606.

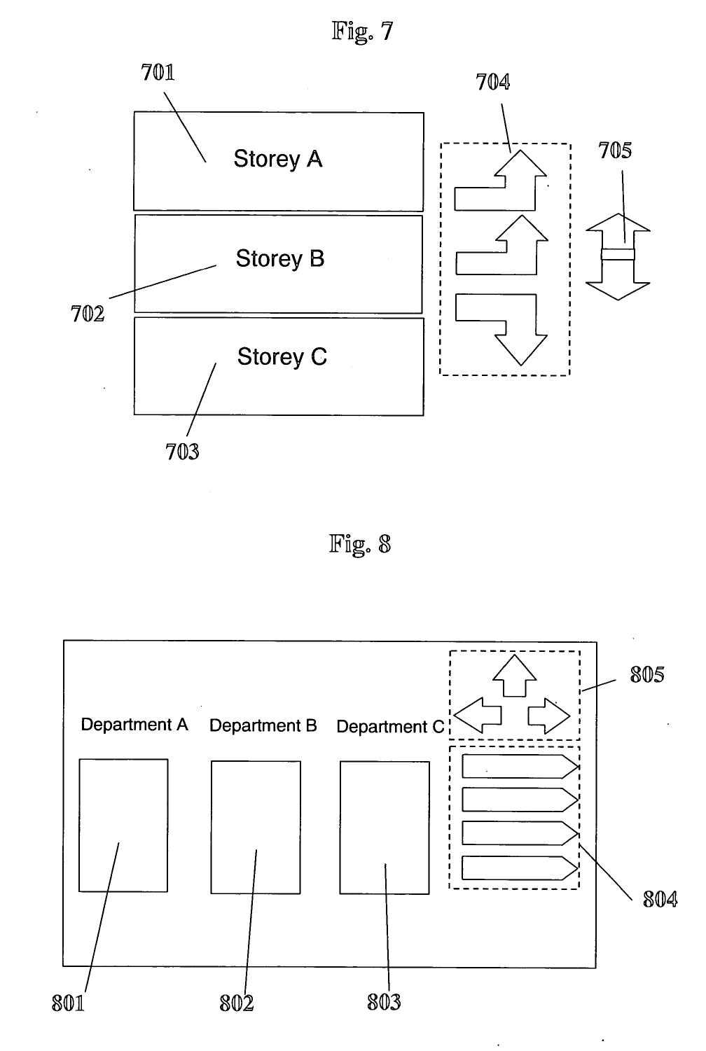

FIG. 7 shows a typical Visual Library classification based on inner building units i.e. stories and titles. For instance, stories 701,702, and 703 (not limited to three numbers) represent three different parts in classification. The representative building inner units (i.e. stories) can be in the form of plan view, elevation view, end view or in 3-D effect in graphic or photographic format. The Visual Library can be divided into multiple web pages or interfaces and linked with directory signboard 704 or navigation arrows 705.

FIG. 8 shows a typical Visual Library classification based on inner building units and titles. For instance, units 801,802, and 803 (not limited to three numbers) represent three different parts in classification. The representative inner units can be doors, windows, partitions etc. They can be in the form of plan view, elevation view, end view or in 3-D effect in graphic or photographic format. The Visual Library can be divided into multiple web pages or interfaces and linked with directory signboard 804 or navigation arrows 805.

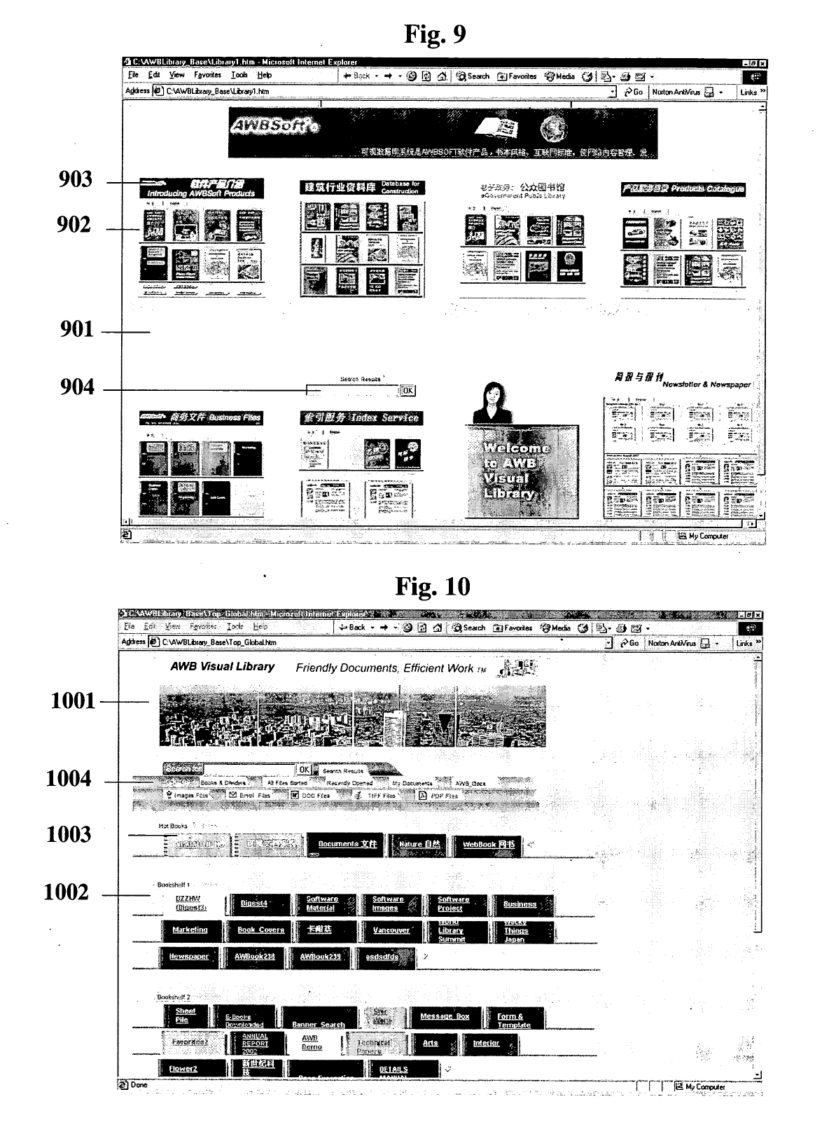

FIG. 9 illustrates an example of a typical Visual Library that comprises Visual Bookshelves. In preferred embodiments, the background with the look-and-feel of a physical library 901 is displayed. In the Visual Library, there are Visual Bookshelf Images 902, titles of classification 903 search engine 904 for searching the contents and classifications of the Visual Library. Users click Visual Bookshelf Image 902 or title 903 to display Visual Bookshelf 201. It is shown in FIG. 2 linked by the Visual Bookshelf Image.

FIG. 10 illustrates an example of a typical stripe style Visual Library that comprises Visual Bookshelves. In preferred embodiments, a background with look-and-feel of a physical library 1001 is displayed. In the Visual Library, there are Visual Bookshelves 1002 and Visual Book Covers 1003, as well as search engine and document indexes 1004. Users click Visual Book Covers 1003 to display a Visual Book.

Typical Variations of Visual Bookshelves

Preferably, a Visual Library comprises a series of Visual Bookshelf Images that link to the Visual Bookshelves. Alternatively, a Visual Library comprises a series of Visual Bookshelves that directly display the Visual Book Covers that link to the Visual Books respectively. Alternatively, a Visual Library comprises both Visual Bookshelves and Visual Bookshelf Images.

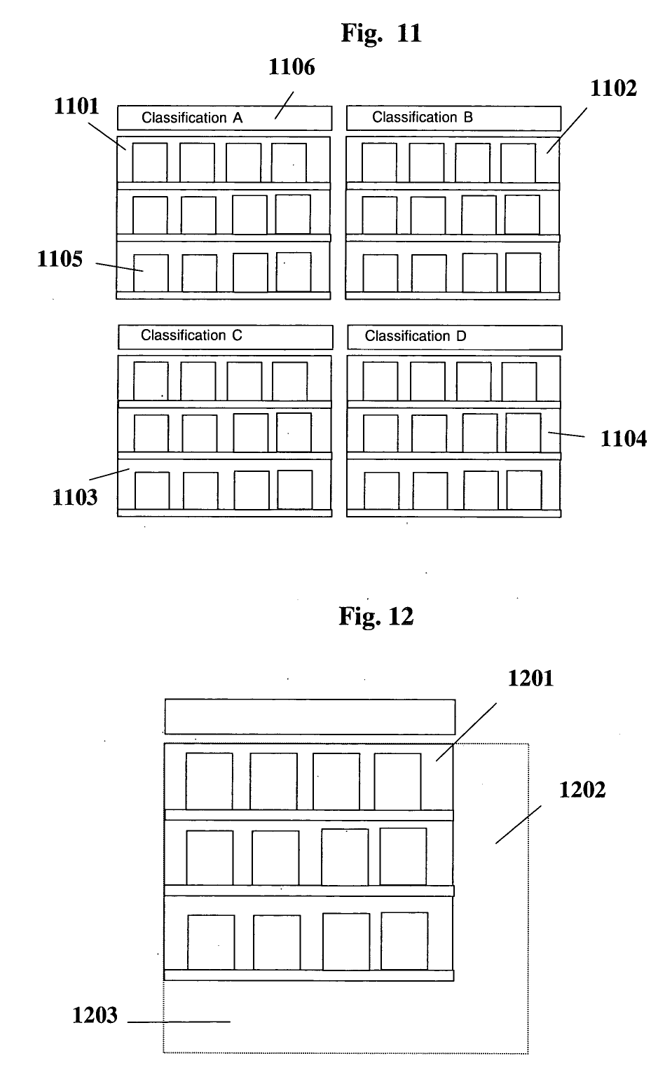

FIG. 11 shows a typical layout of Visual Bookshelves in a Visual Library in preferred embodiments. In Visual Bookshelf 1101, Visual Book Covers 1105 can be added on to Visual Bookshelves. In the Visual Library, Visual Bookshelves 1101, 1102, 1103 and 1104 can be added. Titles 1106 are used to indicate the classification of Visual Bookshelves. FIG. 9 illustrates an example of this type of Visual Library.

FIG. 3 shows a Visual Library with a set of typical stripe style Visual Bookshelves. Visual Book Covers 303 can be added on Visual Bookshelf 301. Visual Bookshelf 304 can be added.

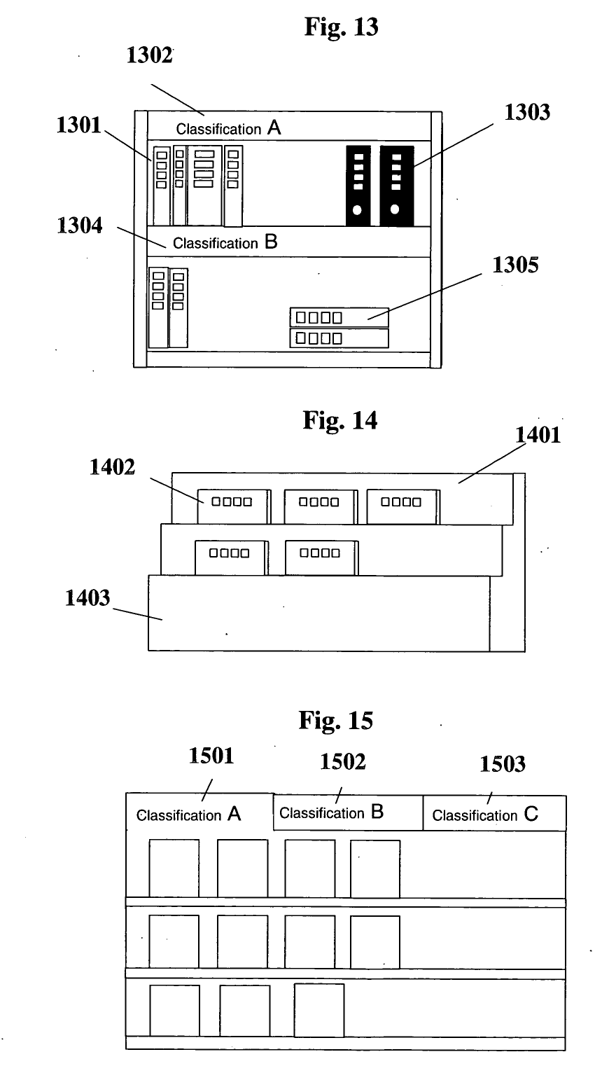

FIG. 12 shows how a typical Visual Bookshelf 1201 can be expanded in two directions, which are horizontal direction 1202 and vertical direction 1203. Visual Book Covers can also be added onto these parts. FIG. 13 shows a typical variation of Visual Bookshelf in which Visual Book Covers 1301 are in side view. Here, Visual Book Covers can be in book style 1301 or file style 1303. Visual Book Covers can be laid down as shown in 1305. Also, titles 1302 and 1304 can be used for classification.

FIG. 14 shows a typical variation of Visual Bookshelf in which the lower portions of Visual Book Covers 1402 are hidden and Visual Bookshelf 1401 is featured in 3-D effect. Such variations in style are within range of Visual Bookshelf.

FIG. 15 shows typical Visual Bookshelves with tabs on top. Current tab with title 1501 indicates the current position. Non-current tabs 1502 and 1503 represent and link to the other Visual Bookshelves behind the current Visual Bookshelf.

FIG. 16 shows typical Visual Bookshelves with tabs on side. Current tab with title 1601 indicates the current position. Non-current tabs 1602 and 1603 represent and link to the other Visual Bookshelves behind the current Visual Bookshelf.

FIG. 17 shows typical 3-D effect Visual Bookshelves with titles. Current Visual Bookshelf 1701 is in front. Non-current Visual Bookshelves are represented and linked with titles 1702. Navigation arrows 1703 can be used to link the Visual Bookshelves.

FIG. 18 shows typical 3-D effect Visual Bookshelves with titles, which is similar to that of FIG. 17 but the Visual Bookshelves are arranged along curve 1801. Navigation arrows 1802 can be used to link the Visual Bookshelves.

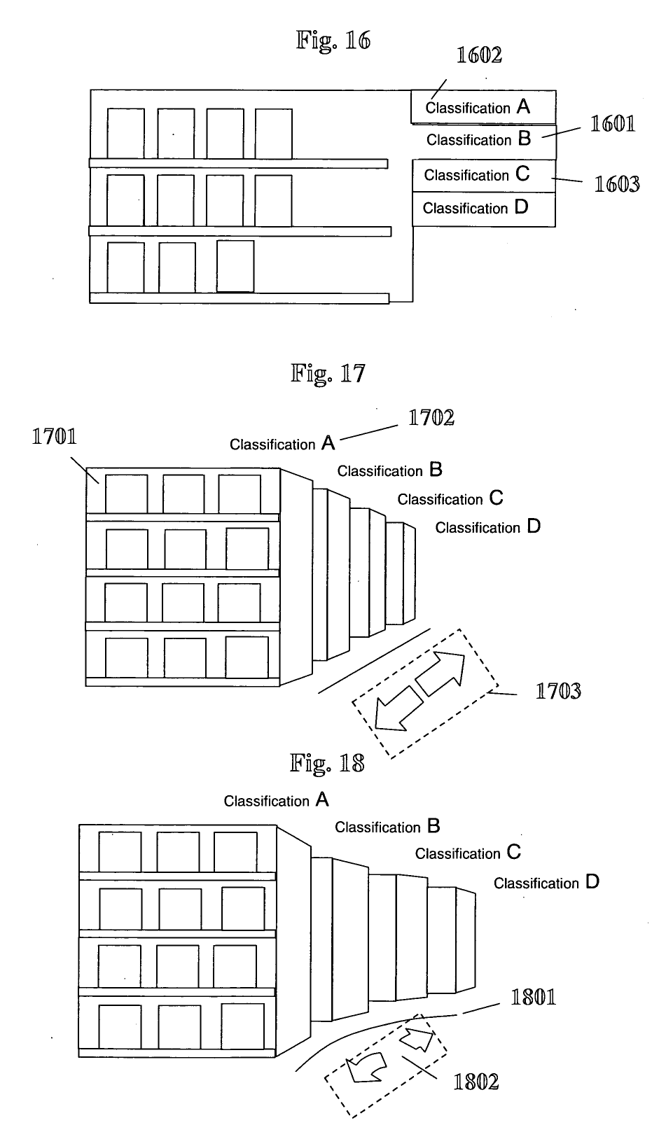

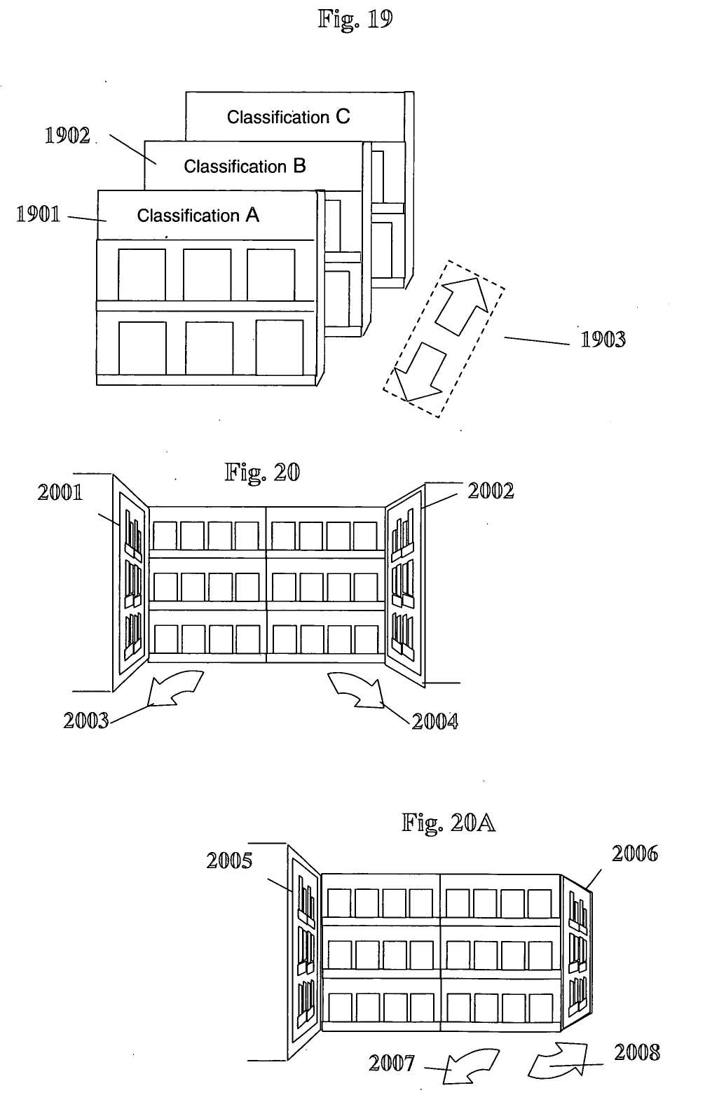

FIG. 19 shows typical 3-D effect Visual Bookshelves with titles 1901 on top. The current Visual Bookshelf with its title 1901 is at the front and more non-current Visual Bookshelves are represented and linked with titles 1902. Navigation arrows 1903 can be used to link the Visual Bookshelves. The Visual Bookshelves in FIG. 15, FIG. 16, FIG. 17, FIG. 18, FIG. 19, are not limited to the number indicated.

FIG. 20 shows typical 3-D effect Visual Bookshelves arranged in a room. Current Visual Bookshelf is located at the center. Two images at the side represent and link non-current Visual Bookshelves 2001 and 2002. Navigation arrows 2003 and 2004 can be used to link the Visual Bookshelves.

FIG. 20A shows typical 3-D effect Visual Bookshelves arranged in a Z-shape. Current Visual Bookshelf is located at the center while two images at the side represent and link non-current Visual Bookshelves 2005 and 2006. Navigation arrows 2007 and 2008 can be used to link the Visual Bookshelves.

Typical Layout of Visual Bookshleves

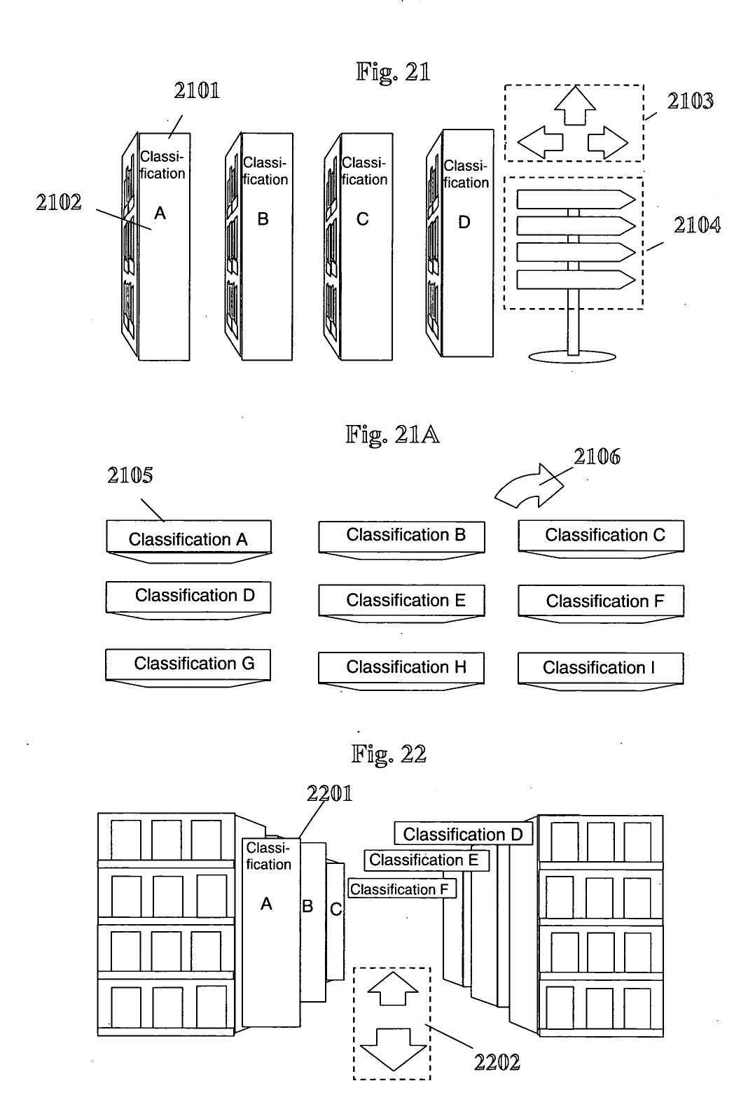

FIG. 21 shows typical side-view effect Visual Bookshelf Images in rows in a Visual Library environment. There is classification titles 2101 on the Visual Bookshelf Images. When titles 2101 or one of the Visual Bookshelf Images is clicked, the represented Visual Bookshelf will be displayed. When Visual Book Covers on the Visual Bookshelf is clicked, the represented Visual Book will be displayed. Navigation arrows 2103 and navigational signboard 2104 can be used to link to specified locations of Visual Library.

FIG. 21A shows typical plan-view effect Visual Bookshelf Images in rows in a Visual Library environment. There is classification titles 2105 on the Visual Bookshelf Images. When one of titles 2105 or one of the Visual Bookshelf Images is clicked, the represented Visual Bookshelf will be displayed. When one of the Visual Book Covers on the Visual Bookshelf is clicked, the represented Visual Book will be displayed. Navigation arrows 2106 or a navigational signboard can be used to link to specified locations of Visual Library.

FIG. 22 shows typical 3-D effect Visual Bookshelves in a Visual Library environment. There is classification titles 2201 besides Visual Bookshelf Images. When the one of titles 2201 or one of the Visual Bookshelf Images is clicked, the represented Visual Bookshelf will become the current bookshelf. Navigation arrows 2202 can be used to link the Visual Bookshelves.

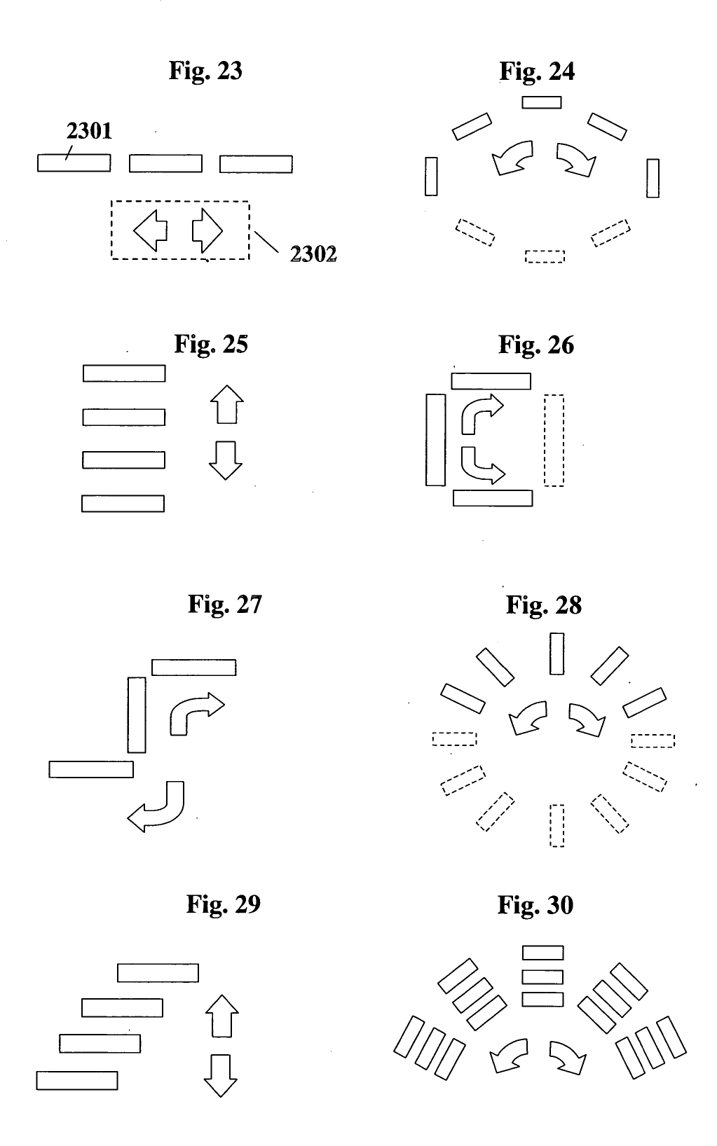

In a Visual Library environment, typical layouts of Visual Bookshelves are illustrated in FIG. 23, FIG. 24, FIG. 25, FIG. 26, FIG. 27, FIG. 28, and FIG. 29.

FIG. 23 shows a typical layout of Visual Bookshelves 2301 in a straight row horizontally with navigation arrows 2302.

FIG. 24 shows a typical layout of Visual Bookshelves in a curve or a circle.

FIG. 25 shows a typical layout of Visual Bookshelves in a straight row vertically. FIG. 15, FIG. 16, FIG. 17, FIG. 19 FIG. 21 and FIG. 22 use the layout in FIG. 25.

FIG. 26 shows a typical layout of Visual Bookshelves in a room unit, which indicates the same layout of Visual Bookshelves in FIG. 20.

FIG. 27 shows a typical layout of Visual Bookshelves a Z-shape, which indicates the same layout of Visual Bookshelves in FIG. 20A.

FIG. 28 shows a typical layout of Visual Bookshelves in a curve or a circle, which indicate the same layout of Visual Bookshelves in FIG. 18.

FIG. 29 shows a typical variation in the layout of Visual Bookshelves in FIG. 25.

FIG. 30 shows a typical combination in the layout of Visual Bookshelves in FIG. 25 and FIG. 28.

FIG. 29 and FIG. 30 indicate the typical variations and combinations in layout of Visual Bookshelves respectively. More variations and combinations based on the layouts described above are within range of the invention.

Visual Book Cover and its Typical Variations

A Visual Book Cover is a representative unit on a Visual Bookshelf that links to the represented Visual Book.

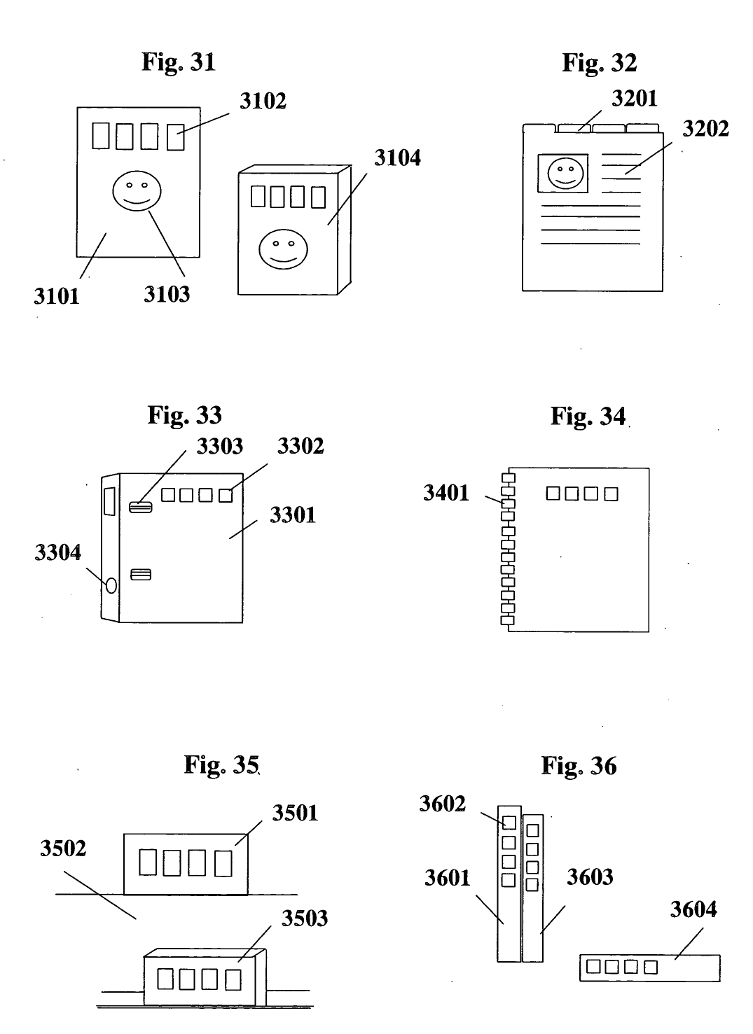

FIG. 31 shows a typical Visual Book Cover, which comprises cover 3101 and title 3102 linking to the represented Visual Book. Additionally, image 3103 can be included. Preferred, title 3102 can be text combining image units to form a Visual Book Cover. Alternatively, title 3102 can be multiple images combined together. Alternatively, Visual Book Cover can be a single image with title 3102. 3-D style Visual Book Cover 3104 is a typical variation in style.

FIG. 32 shows a typical Visual Book Cover that represents paper documents. An image of the first page of paper documents 3202 and tabs that represent multiple pages of papers 3201 are displayed on the Visual Book Cover.

FIG. 33 shows typical variation of Visual Book Cover—Visual File, which comprises cover 3301, title 3302 and visual elements such as binders 3303 and grip hole 3304. The Visual File can be in 2-D or 3-D style.

FIG. 34 shows a typical Visual Book Cover with visual binding elements 3401 that illustrate the variation in styles.

FIG. 35 shows typical Visual Book Cover 3501 in which the lower portion is hidden visually in the bookshelf 3502. 3-D style Visual Book Cover 3503 that is half hidden.

FIG. 36 shows a typical Visual Book Cover in side view style. Side view Visual Book Cover 3601 comprises title 3602, which can be in either text or image format. Side view Visual Book Cover can be either in standing style 3603 or lying style 3604.

Hierarchical Structure of Visual Library Objects

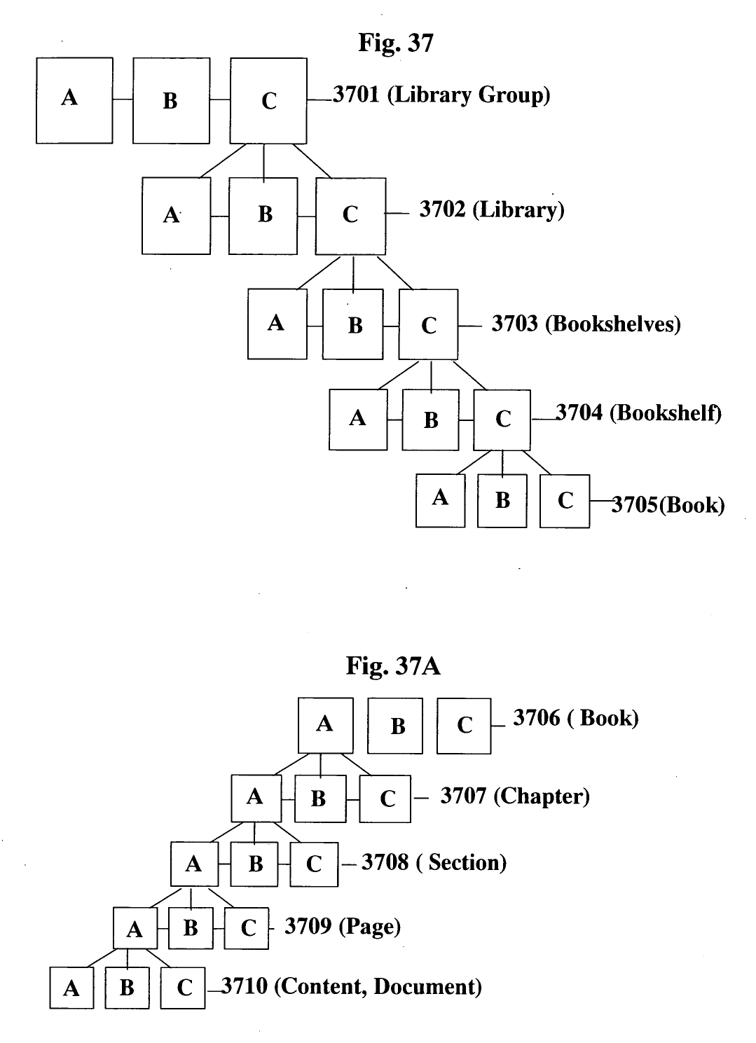

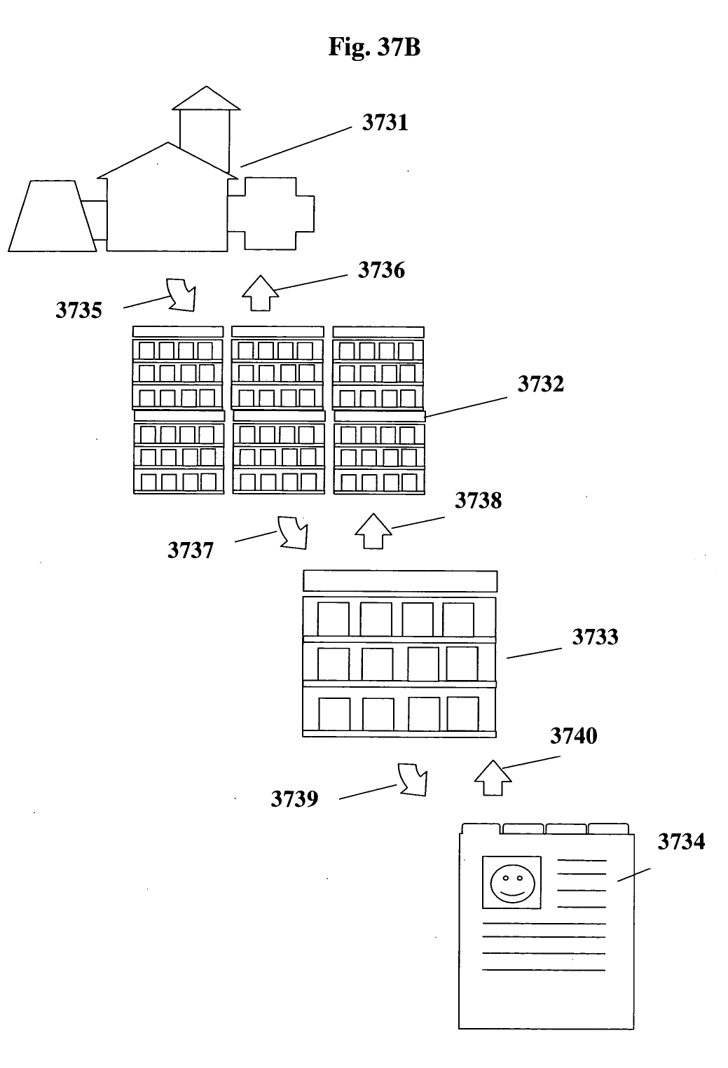

FIG. 37 shows a typical hierarchical structure of Visual Libraries, Visual Bookshelves and Visual Books, which is similar to the hierarchical structure of the directory and file system. Level 3701 represents the Visual Library Group in which A, B and C represent the different Visual Libraries in the same level. Level 3702 represents a Visual Library in which A, B and C represent the different sections of a Visual Library in the same level. Level 3703 represents a Visual Bookshelf Group in which A, B and C represent different Visual Bookshelves or Visual Bookshelf Images in the same level. Level 3704 represents a Visual Bookshelf in which A, B and C represent different Visual Bookshelves in the same level. Level 3705 represents Visual Book in which A, B and C represent the different Visual Book Covers in the same level. In any level described above the three units, A, B, C are taken as examples but the number of units is not limited to three. In preferred embodiments, not every level described above must be included.

The level of Visual Books is an essential and typical hierarchical structure below the level of Visual Book is shown in FIG. 37A. Level 3706 represents Visual Books in which A, B, C represent the different Visual Book Covers in the same level. Level 3707 represents Chapters of a Visual Book in which A, B and C represent different chapters in the same level. Level 3708 represents Sections of a Visual Book in which A, B and C represent the different sections in the same level. Level 3709 represents Pages of a Visual Book in which A, B and C represent the different pages in the same level. Level 3710 represents Contents in a Visual Book in which A, B and C represent the different contents or documents in the same level. In any level described above, the three units A, B, C are taken as examples but the number of units is not limited to three. In preferred embodiments, not every level described above must be included.

FIG. 37B shows a hierarchical linking structure in a typical Visual Library. 3731 represents the top level of a Visual Library and 3732 represents Visual Bookshelf Images in a Visual Library. 3733 represents a Visual Bookshelf and 3734 represents a Visual Book. At higher levels, when a unit that represents a lower level is clicked, the lower level environment will be displayed in directions as 3735, 3737 and 3739. In lower levels, navigation arrows 3736, 3738 and 3740 link to upper levels.

Visual Book and Visual Navigation Tabs

A group of navigation tabs that link a series of web pages or a series of user interfaces (i.e. forms) that also indicate the current location of the pages or interfaces are named Visual Navigation Tabs. The Visual Navigation Tabs can be in form of text, graphics or images, or their combinations. In preferred embodiments, Visual Navigation Tabs have the look-and-feel of physical indexing tabs of books. A series of web pages or a series of user interfaces that are linked as a unit by Visual Navigation Tabs is named Visual Book. In preferred embodiments, Visual Book has the look-and-feel of physical books or files.

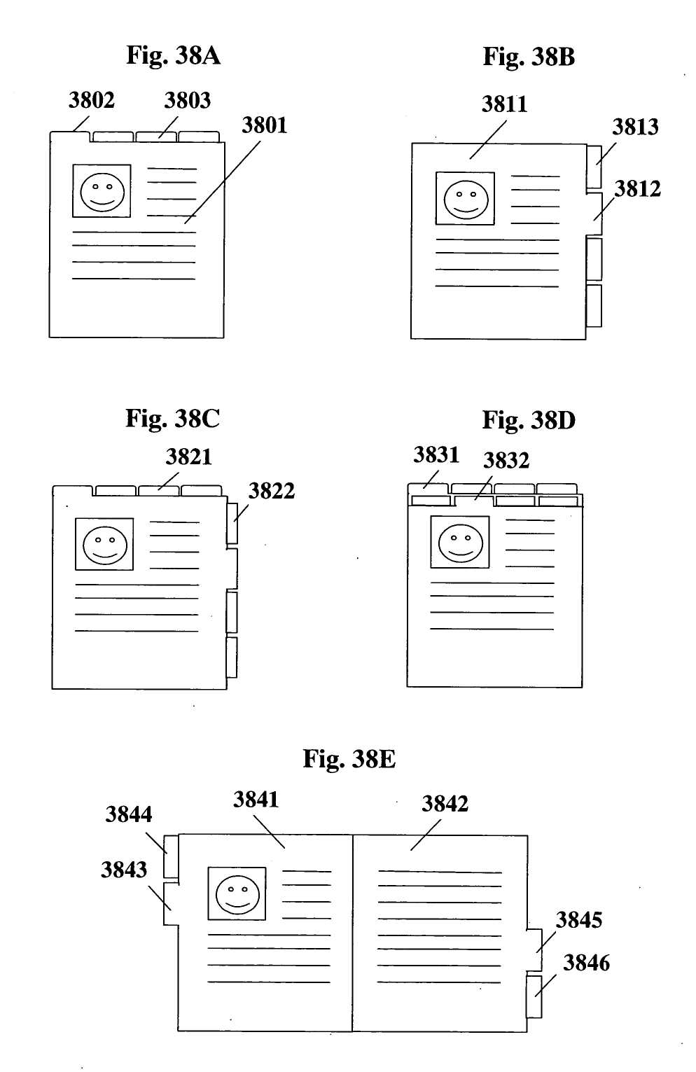

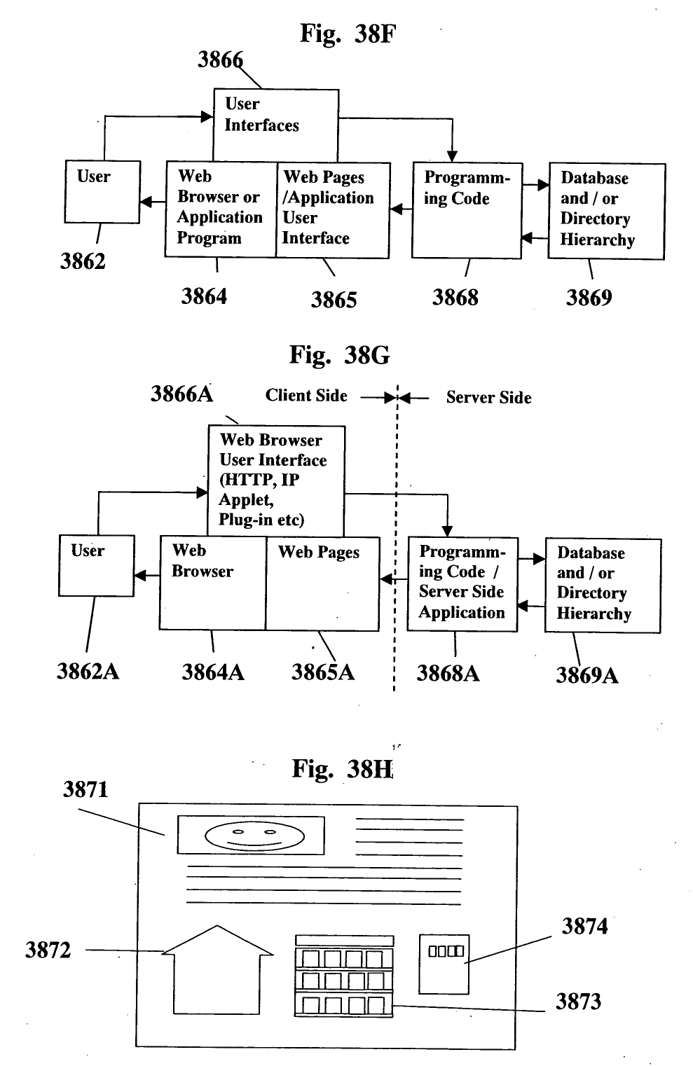

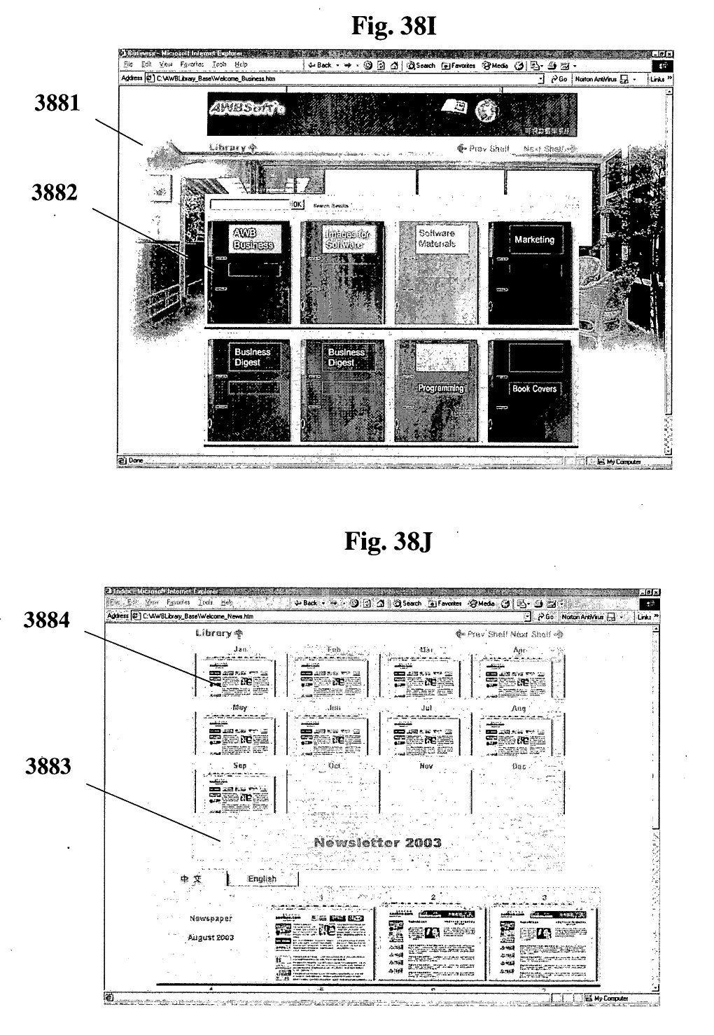

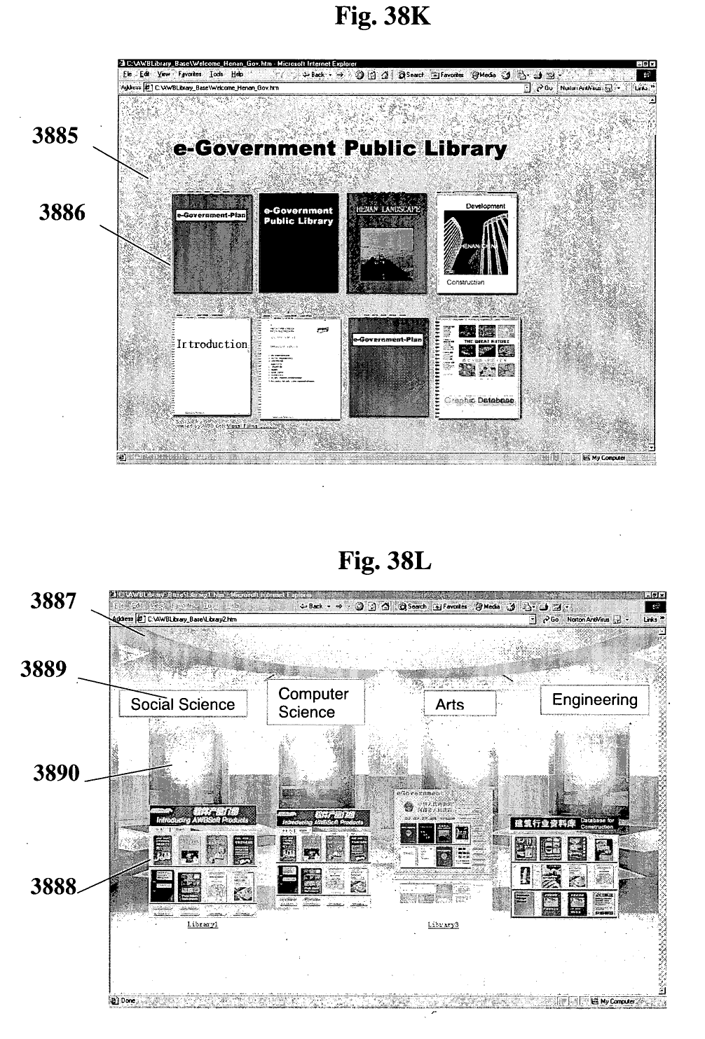

FIG. 38A shows a typical Visual Book with Visual Navigation Tabs on top. Current book page 3801 and a set of Visual Navigation Tabs are displayed. Current tab 3802 represents the current page and non-current tabs 3803 represent non-current pages.

FIG. 38B shows a typical Visual Book with Visual Navigation Tabs on one side. Current book page 3811 and a set of Visual Navigation Tabs are displayed where current tab 3812 represents the current page and non-current tabs 3813 represent non-current pages.

FIG. 38C shows a typical Visual Book with Visual Navigation Tabs both on top and on one side. Either top Navigation Tabs 3821 or side Navigation Tabs 3822 can be of higher level.

FIG. 38D shows a typical Visual Book with Visual Navigation Tabs in two levels on top. Visual Navigation Tabs 3831 is at the upper level while Visual Navigation Tabs 3832 is at the lower level.

FIG. 38E shows a typical two-page Visual Book with Visual Navigation Tabs on two sides. Here, the web page or interface is in the form of two pages visually. Left page 3841 is represented by left current tab 3843. Right page 3842 is represented by right current tab 3845. In FIG. 38E, 3844 and 3846 represent the non-current pages at left side and right side respectively. The current tabs always indicate current location. Visual Navigation Tabs can be also located at the top.

Generation and Updating of Visual Library Objects

In one of the embodiments, the web pages of Visual Libraries, Visual Bookshelves or Visual Books can be manually or half-manually generated with web page editing tools, as well as image editing tools for images used as elements of the web pages.

In preferred embodiments, the web pages of Visual Library, Visual Bookshelf or Visual Books are generated with the support of programming codes. Image elements can be ready-made from image editing tools or generated automatically with the support of programming codes. Structural data such as the titles or classification criteria are incorporated for generation and updating.

The programming code used for supporting generation and updating can be located in the user's machine or located in remote machine (i.e. network or web server). Typically, there are some web pages in the Visual Library environment. Users can generate or customize Visual Bookshelves or Visual Books using the local computer, network computers or severs. Typically, generation and updating have become real-time operations with the user's navigation of Visual Library.

FIG. 38F is a flowchart showing, how to customize a Visual Library, a Visual Bookshelf or a Visual Book from user interfaces in the local computer in one preferred embodiment. Here, the method and system is applied at the user's machine only, while the programming codes can be built-in modules in an implemented web browser or a stand-alone application, including hypertext web viewers. Refer to FIG. 38F, when user 3862 navigates web pages 3865 or user interfaces 3865 on web browser or application program 3864, a request can be sent via application interface 3866 to programming code 3868. The program processes the request and updates database 3869 and/or directory hierarchy 3869 of the system. Based on updated database 3869 and/or directory hierarchy 3869, programming codes 3868 updates and generates web pages or user interfaces 3865 and present them on web browser or application program 3864 to user 3862.

FIG. 38G is a flowchart showing how to customize a Visual Library, Visual Bookshelf or a Visual Book over client/server network in preferred embodiments. The method and system is applied to client/server architecture over network. When network user 3862A navigates web pages 3865A via web browser 3864A, a request can be sent via user interface 3866A, which includes Internet mechanism HTTP, IP, Applet, ActiveX and plug-in etc. The request is sent to server programming codes 3868A. Programming codes 3868A processes the request and updates database 3869A and/or directory hierarchy 3869A of the system. Based on updated database 3869A and/or directory hierarchy 3869A, programming codes 3868A updates and generates web pages 3865A and also presents the web pages on web browser 3864A to user 3862A. Although the method in FIG. 38G is typical for client/server architecture over network, the method is also applicable for wide area network, local area network and the local computer system.

Links on Web Pages to Visual Library Objects

FIG. 38H indicates typical ways to link a Visual Library, a Visual Bookshelf or a Visual Book from an ordinary web page or a web page on a web portal. On web page 3871, image 3872 represents and links to a Visual Library. Image 3873 represents and links to a Visual Bookshelf. Image 3874 represents and links to a Visual Book. Alternatively, images 3871, 3872 and 3873, can be in either graphic or text format or their combinations to represent and link the Visual Library objects.

Alternative Naming, Styles and Combinations of Visual Library Objects

The invention is a method and a system to present web pages or user interfaces in organized structures and visualized styles described above. The names of Visual Library, Visual Bookshelf, Visual Book are specified to represent the objects in preferred embodiments. If the methods described above are used while the alternative names or styles such as Visual Office, Visual Buildings, Visual Data Base, Visual Archiving, Visual Cabinet Visual Files, Visual Journal or Visual Album etc are applied, they are still within the range of this invention. Such kinds of alternative names and styles are further described below.

FIG. 38I illustrates an example of a Visual Bookshelf in which Visual Book Covers are in the form of Visual Files. Where 3881 is the background, 3882 is in the style of Visual Files, an alternative name and style of Visual Books or Visual Book Covers.

FIG. 38J illustrates an example of a Visual Bookshelf in which the Visual Book Covers are in the form of documents and newspapers. 3883 and 3884 are in the style of documents or newspapers, which are alternative names and styles of Visual Books or Visual Book Covers.

FIG. 38K illustrates an example of a Visual Bookshelf named 3885, in which there is no background or borders of bookshelf, but there are still Visual Book Covers as 3886 so it still a Visual Bookshelf in spite there is no obvious look-and-feel of a physical bookshelf.

FIG. 38L illustrates an example of a Visual Library in which titles for classifications are based on both building units and Visual Bookshelves on a single interface. Where 3387 is the background of the library, 3388 are Visual Bookshelves, 3390 are the building units (doors) and 3889 are titles for classifications.

1. A method of making web pages on the local computer, computer over the network, server, digital device or digital processing system, the method comprising:
generating a web page or a set of web pages which includes a Visual Bookshelf or a set of Visual Bookshelves;
said Visual Bookshelf comprises Visual Book Covers which represent Visual Books and link to the represented Visual Books respectively;
said Visual Book comprises Visual Navigation Tabs which represent a set of web pages and link to the represented web pages respectively.

2. The method according to claim 1, wherein said web pages including Visual Bookshelf is written in markup language such as HTML, SGML, XML, XHTML or their sister, extension and successor languages.

3. The method according to claim 1, wherein said Visual Bookshelf, with support of software program, is assembled dynamically with graphics (and/or images) and titles which match together by the syntax of the markup language, to the present look-and-feel of bookshelves.

4. The method according to claim 1, wherein said Visual Book Cover, with support of software program, is assembled dynamically with graphics (and/or images) and titles which match together by the syntax of markup language, to present look-and-feel of bookshelves.

5. The method according to claim 1, wherein said Visual Bookshelves and Visual Books are dynamically written based on a database, a data file or a XML file, or their combination, with support of software program, said database, a data file or a XML file can be an existing one or created in response of a request from user interface locally or over network.

6. The method according to claim 1, wherein said Visual Bookshelves and Visual Books are generated dynamically based on the structure of an existing hierarchical directory tree in a computer's file system or local/network storage system, with support of software program.

7. The method according to claim 1, wherein said Visual Bookshelves are virtually arranged in lines and rows by modeling the physical bookshelves and presented in elevation view, side view, end view, plan view or 3-D effect view.

8. The method according to claim 1, wherein said Visual Book Covers are presented in front view, side view or 3-D effect view and arranged either in horizontal or vertical line; the cover is either in full view or partially hidden in the bookshelf; the cover (book) in side view is either standing or lying down.

9. The method according to claim 1, wherein said Visual Book Covers are presented in one style of physical books, files, journals, albums, notebooks and document papers or newspapers.

10. The method of claim 1 further including:
generating a new Visual Book Cover on a Visual Bookshelf in response to a request from user interface with support of software program;
generating a new Visual Book as the generation of the new Visual Book Cover with support of software program;
automatically creating a link on the new Visual Book Cover to the new Visual Book.

11. The method according to claim 1, wherein said web page for presenting Visual Bookshelves that comprise links to Visual Library or Visual Library Group or other Visual Bookshelves.

12. A method of making web pages on the local computer, computers over the network, servers, digital devices or digital processing systems, the method comprising:
generating a web page or a set of web pages which includes a Visual Library;
said Visual Library comprises Visual Bookshelf or Visual Bookshelves or representative images of Visual Bookshelf.

13. The method according to claim 12, wherein said Visual Library has the look-and-feel of physical library in image or graphic format, and the classifications of libraries are based on the units in forms of buildings, stories, door or windows.

14. The method according to claim 12, wherein said Visual Library is written dynamically based on a database, a data file or a XML file, or their combination, with support of software program, said database, a data file or a XML file can be an existing one or one created in response of a request from user interfaces locally or over the network.

15. The method according to claim 12, wherein said Visual Library is generated dynamically based on the structure of an existing hierarchical directory tree in a computer's file system or local/network storage system, with support of software program.

16. A method of making graphic user interfaces on the local computer, computers over the network, servers, digital devices or digital processing systems, the method comprising:
generating a form or a set of forms which includes a Visual Bookshelf or a set of Visual Bookshelves;
said Visual Bookshelf comprises Visual Book Covers which represent Visual Books and link to the represented Visual Books respectively;
said Visual Book comprises Visual Navigation Tabs which represent a set of forms and link to the represented forms respectively.

17. The method according to claim 16, wherein said Visual Bookshelf, with support of software program, is assembled dynamically with graphics (and/or images) and titles which match together, to present the look-and-feel of bookshelves.

18. The method according to claim 16, wherein said Visual Book Cover, with support of software program, is assembled dynamically with graphics (and/or images) and titles which match together to present look-and-feel of bookshelves.

19. The method according to claim 16, wherein said Visual Bookshelves and Visual Books are written dynamically based on a database, a data file or a XML file, or their combination, with support of software program, said database, a data file or a XML file can be an existing one or created in response of a request from user interfaces locally or over network.

20. The method according to claim 16, wherein said Visual Bookshelves and Visual Books are generated dynamically based on the structure of an existing hierarchical directory tree in the computer's file system or local/network storage system, with support of software program.

21. The method according to claim 16, wherein said Visual Bookshelves are virtually arranged in lines or rows by modeling the physical bookshelves and presented in elevation view, side view, end view, plan view or 3-D effect view.

22. The method according to claim 16, wherein said graphic user interfaces for presenting Visual Bookshelf or Visual Bookshelves comprises link or links to Visual Library or Visual Library Group or other Visual Bookshelves;
said Visual Library has the look-and-feel of a physical library in image or graphic format and the classifications of library are based on the building units.
